(19) United States
(12) Patent Application Publication
(10) Pub. No.: US 2008/0077489 A1
(43) Pub. Date: Mar. 27, 2008

(54) Rewards systems

(75) Inventors: Glenn Gregory Gilley, Los Altos, CA (US); Sarah A. Brody, Santa Clara, CA (US); Randall Hayes Ubillos, Los Altos, CA (US); Mihnea Calin Pacurariu, Los Gatos, CA (US)

Correspondence Address: ROPES & GRAY LLP;PATENT DOCKETING 39/361, 1211 AVENUE OF THE AMERICAS, NEW YORK, NY, 10036-8704, US

(73) Assignee: Apple Inc., Cupertino, CA (US)

(21) Appl. No.: 11/729,170

(22) Filed: Mar. 27, 2007

Related U.S. Application Data
(60) Provisional application No. 60/846,414, filed on Sep. 21, 2006.

(51) Int. Cl. G06Q 30/00

(52) U.S. Cl. 705/14

(57) ABSTRACT

Rewards systems for permitting a user to motivate one or more other users to perform predetermined activities are provided. A rewards system of the present invention can permit a supervisory user to set up rewards allocation parameters by which the rewards system can automatically distribute rewards to a subordinate user. Once the subordinate user has input data about his activities, the rewards system can determine the appropriate rewards to distribute to the subordinate user account based on the data and the rewards allocation parameters. A rewards system of the present invention also can permit a user to challenge one or more users to a competition. Based on data about the competitors' activities and user-defined allocation parameters, the rewards system can automatically distribute rewards to the user account(s) of victorious competitor(s).

### CROSS-REFERENCE TO RELATED APPLICATIONS

This claims priority to U.S. Provisional Patent Application No. 60/846,414 to Gilley et al., filed on Sep. 21, 2006 (referred to below as “the incorporated provisional patent application”), the entirety of which is incorporated herein by reference.

This also is related to:

U.S. patent application Ser. No. ______ to Gilley et al., filed on Mar. 27, 2007, entitled “LIFESTYLE COMPANION SYSTEM,” Attorney Docket No. 104677-0019-101/P4725US1 (referred to herein as “the incorporated LIFESTYLE COMPANION document”), the entirety of which is incorporated herein by reference;

U.S. patent application Ser. No. ______ to Gilley et al., filed on Mar. 27, 2007, entitled “SYSTEMS AND METHODS FOR PROVIDING AUDIO AND VISUAL CUES VIA A PORTABLE ELECTRONIC DEVICE,” Attorney Docket No. 104677-0019-10/P4725US2 (referred to herein as “the incorporated AUDIO AND VISUAL CUES document”), the entirety of which is incorporated herein by reference;

U.S. patent application Ser. No. ______ to Gilley et al., filed on Mar. 27, 2007, entitled “DYNAMICALLY ADAPTIVE SCHEDULING SYSTEM,” Attorney Docket No. 104677-0019-103/P4725US3 (referred to herein as “the incorporated ADAPTIVE SCHEDULING SYSTEM document”), the entirety of which is incorporated herein by reference;

U.S. patent application Ser. No. ______ to Gilley et al., filed on Mar. 27, 2007, entitled “SYSTEMS AND METHODS FOR FACILITATING GROUP ACTIVITIES,” Attorney Docket No. 104677-0019-104/P4725US4 (referred to herein as “the incorporated GROUP ACTIVITIES document”), the entirety of which is incorporated herein by reference;

U.S. patent application Ser. No. ______ to Gilley et al., filed on Mar. 27, 2007, entitled “VARIABLE I/O INTERFACE FOR PORTABLE MEDIA DEVICE,” Attorney Docket No. 104677-0025-101/P4732US1 (referred to herein as “the incorporated VARIABLE I/O document”), the entirety of which is incorporated herein by reference; and

U.S. patent application Ser. No. ______ to Dorogusker et al., filed on Mar. 27, 2007, entitled “INTEGRATED SENSORS FOR TRACKING PERFORMANCE METRICS,” Attorney Docket No. 104677-0035-101/P4768US1 (referred to herein as “the incorporated INTEGRATED SENSORS document”), the entirety of which is incorporated herein by reference.

The incorporated provisional patent application, LIFESTYLE COMPANION document, AUDIO AND VISUAL CUES document, ADAPTIVE SCHEDULING SYSTEM document, GROUP ACTIVITIES document, VARIABLE I/O document, and INTEGRATED SENSORS document collectively are referred to herein as “the incorporated patent documents.”

### FIELD OF THE INVENTION

The present invention can relate to systems for permitting a user to reward one or more other users for performing predetermined activities.

### BACKGROUND OF THE INVENTION

Physical fitness may not be sufficient motivation for some people to exercise when they are faced with hectic lifestyles, fatigue, and opportunities to spend their time playing video games, watching television, or performing other sedentary activities. Likewise, general health may not be sufficient motivation for some people to eat nutritiously when they are faced with hectic lifestyles and a plethora of unhealthy food options.

### SUMMARY OF THE INVENTION

The present invention includes methods and systems for permitting one or more users to reward one or more other users for performing predetermined activities, e.g., exercise and/or eating nutritiously.

A rewards system of the present invention can permit a supervisory user, e.g., a parent or trainer, to distribute rewards to a subordinate user (e.g., a child or athlete) based on the amount and/or quality of activity the subordinate user performs. The rewards system can permit a supervisory user to purchase rewards from a commercial transaction server. Based on allocation parameters defined by the supervisory user and on data indicative of the activities performed by the subordinate user, the rewards system can automatically distribute the purchased rewards from the supervisory user's account to the subordinate user's account. In one embodiment of the present invention, the subordinate user can download his activity data from a tracking device.

The rewards systems of the present invention also can permit a user to challenge one or more other users to a competition. The rewards system can be configured to automatically distribute rewards to the user account(s) of victorious competitor(s) based on user-defined allocation parameters and on data indicative of the activities performed by the competitors.

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIG. 1 illustrates one embodiment of the rewards system of the present invention;

FIG. 2 illustrates one embodiment of a registration process for the rewards system of the present invention;

FIG. 3 illustrates one embodiment of a rewards allocation process for the rewards system of the present invention;

FIG. 4 illustrates relationships among multiple user accounts in accordance with one embodiment of the present invention;

FIGS. 5 and 6 illustrate embodiments of registration processes for competitions administered by the rewards system of the present invention;

FIG. 7 illustrates one embodiment of a rewards allocation process for competitions administered by the rewards system of the present invention;

FIG. 8 illustrates rewards transactions in accordance with one embodiment of the present invention; and

FIG. 9 illustrates functions for user-interaction with the rewards system in accordance with one embodiment of the present invention.

### DETAILED DESCRIPTION OF THE INVENTION

Rewards systems of the present invention can permit a user to distribute rewards to other users who perform one or more activities that meet one or more rewards allocation parameters. The user who is providing the rewards can purchase the rewards from commercial transaction servers, e.g., similar to that offered under the trademark iTunes™ by Apple Computer, Inc. of Cupertino, Calif. The users also may acquire rewards in exchange for purchases from the commercial transaction server or another commercial transaction server or business participating in the rewards system. The user who is providing the rewards also can earn the rewards by performing predetermined activities for which that user is compensated. The types of rewards offered in connection with the rewards systems of the present invention can include (1) rewards points that can be exchanged for merchandise, services, or features; (2) money; (2) access to merchandise, services, or features that would otherwise be unavailable; (3) discounts applicable to future purchases; (4) video game character enhancements, or (5) any combination thereof.

The rewards systems of the present invention can permit users who desire to earn rewards to enter data about the activities they have performed into rewards analysis software run by a tracking device, a local server, a commercial transaction server, a server dedicated to storage of user account information, or any combination thereof. The rewards systems can permit those users to enter their data either manually or by downloading the data from one or more activity tracking devices. Activity tracking devices can include passive tracking devices that require the user to manually enter the activities a user has performed, active tracking devices that automatically log data about the activities a user has performed, or any combination thereof. Active tracking devices can include any electronic device coupled to or incorporating sensors that can capture information about a user's activities, e.g., pedometers, devices having accelerometers, heart rate monitors, oximeters, GPS tracking devices, devices having temperature sensors, devices having heat flux sensors, electrocardiogram devices, devices having activity tracking sensors similar to those described in the incorporated INTEGRATED SENSORS document, devices having activity tracking sensors similar to those described in the other incorporated patent documents, or any combination thereof.

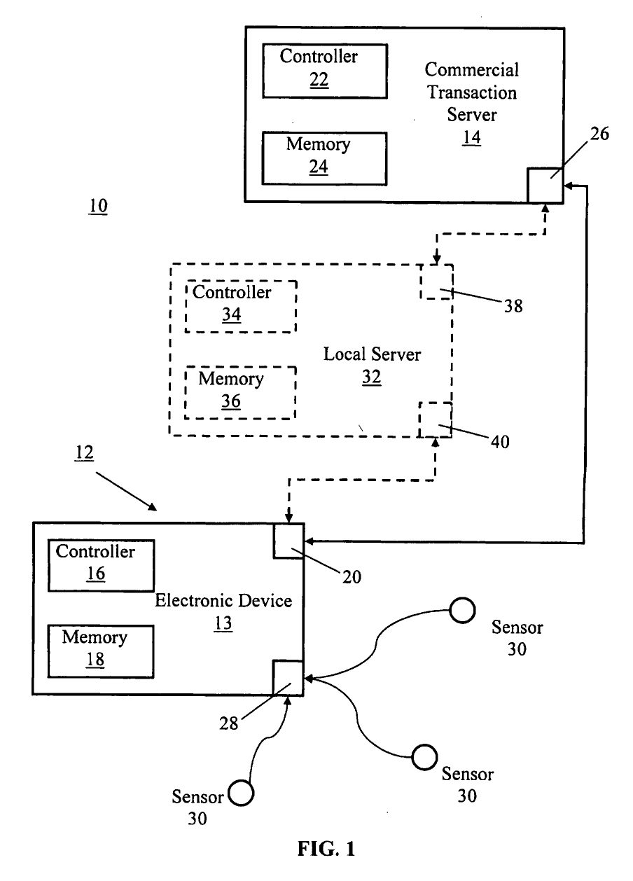

FIG. 1 illustrates one embodiment of a rewards system of the present invention. Rewards system 10 can include active tracking device 12 and commercial transaction server 14. Tracking device 12 can incorporate electronic device 13 and one or more sensors 30. Electronic device 13 can include controller 16, memory 18, communication module 20, and receiver 28. Controller 16 can control tracking device 12 and direct sensor data to be stored in memory 18. In one embodiment of the present invention, controller 16 also can process a portion or all of the registration and rewards allocation processes described below.

Sensors 30 can transmit data to receiver 28 through a wire or by using a wireless protocol known in the art or otherwise. A user can wear sensors 30 in the user's clothing or accessories. Alternatively, sensors 30 can be disposed within electronic device 13 or another electronic device utilized by the user. If sensors 30 are disposed only within electronic device 13, the tracking device may not need receiver 28. In one embodiment of the present invention, active tracking device 12 can include a portable media player similar to that sold under the trademark iPod™ by Apple Computer, Inc. of Cupertino, Calif., and a sensor/receiver kit similar to the Nike+iPod Sport Kit sold by Apple Computer, Inc. of Cupertino, Calif. and Nike, Inc. of Beaverton, Oreg.

In one embodiment of the present invention, commercial transaction server 14 can permit users to register for user accounts and can distribute rewards to users based on data about the users' activities. Users who desire to earn rewards may download data about their activities from their respective active tracking devices 12 into commercial transaction server 14. Commercial transaction server 14 can include controller 22, memory 24, and communication module 26. Memory 24 can store user account information, including name, contact information, rewards available, linked accounts, data downloaded from active tracking devices, other information described below, or any combination thereof. Communication modules 20 and 26 can be configured to transmit signals between portable device 12 and commercial transaction server 14 over a local or wide area network (e.g., the internet). Controllers 16 and 22 can be one or more processors, ASICs, circuits, or any combination thereof.

Rewards system 10 also can include optional local server 32, e.g., a user's personal computer. Local server 32 can serve as an intermediary between active tracking device 12 and commercial transaction server 14. In some embodiments of the present invention, a user may interact with commercial transaction server 14 through local server 32. Controller 34 of local server 32 also can facilitate a portion or all of the registration and rewards allocation processes described herein. Thus, the registration and rewards allocation processes described herein can be executed by one or more of the controllers disposed in tracking device 12, commercial transaction server 14, and local server 32. Local server 32 can communicate with active tracking device 12 and commercial transaction server 14 using communication modules 38 and 40.

Information about user accounts can be stored in the respective memories of commercial transaction server 14, local server 32, and/or tracking device 12. For example, user account information can be stored in commercial transaction server 14 to facilitate transactions among users located in different geographic locations. User account information also can be stored in local server 32 for privacy reasons. User account information also can be divided among device 12, commercial transaction server 14, and/or location server 32.

A rewards system of the present invention can permit a supervisory user (e.g., a parent or trainer) to allocate or distribute rewards to a subordinate user (e.g., a child or athlete) when the subordinate user performs, e.g., a predetermined amount and/or quality of physical activity. The rewards system can evaluate data provided by the subordinate and allocate rewards from the supervisory user account to the subordinate user account based on the allocation parameters set by the supervisor. Once the rewards have been transferred into the subordinate user account, the subordinate can access the rewards immediately, for example, by exchanging the rewards for merchandise, services, or features offered by the commercial transaction server from which the supervisor had purchased the rewards or by other commercial transaction servers offered by partner businesses.

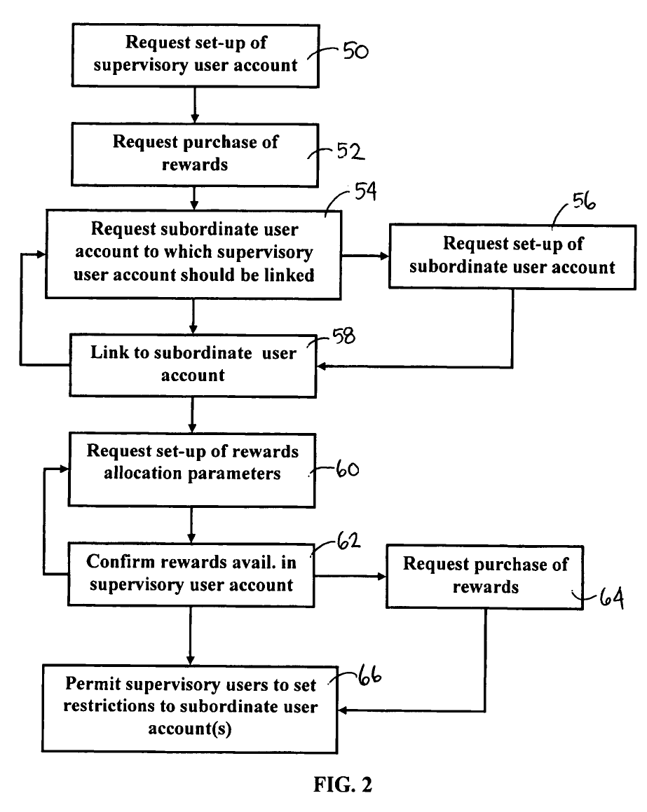

FIG. 2 illustrates one embodiment of a registration process for the rewards system of the present invention. In step 50, the rewards system can request that the supervisor set up a supervisory user account. The rewards system can request that the supervisor input personal information, e.g., name, address, contact information, credit or debit card number, and/or bank account number.

In step 52, the rewards system can request that the supervisor purchase or otherwise acquire rewards as described above. For example, the rewards can be in the form of rewards points and each rewards point can cost $1. The rewards system also can offer specials, such as for bulk purchases (e.g., 100 rewards points for $75). In one embodiment of the present invention, the rewards system can permit the supervisor to choose whether the supervisor wants to have the rewards system to automatically replenish the supervisory user account with a predetermined amount of rewards once the level of rewards diminishes to a predetermined level. If the supervisor does not want the rewards system to automatically replenish the account, the rewards system can notify the supervisor of a low level of rewards, e.g., by way of email, postal mail, fax, audible signal, or by some other means. The rewards system then can associate the rewards purchased or otherwise acquired by the supervisor with the supervisory user account.

In step 54, the rewards system can request that the supervisor indicate a subordinate user account to which the supervisory user account should be linked. If no subordinate user account has been created, the rewards system can request that the supervisor set up a subordinate user account in step 56. To set up the subordinate user account, the rewards system can request that the supervisor enter personal information about the subordinate, e.g., name, address, and/or contact information. In step 58, the rewards system can link the supervisory user account to the subordinate user account. Thereafter, the rewards system can permit the supervisor to link the supervisory user account to additional subordinate user accounts.

In step 60, the rewards system can request that the supervisor set up rewards allocation parameters. Rewards allocation parameters can be any rule by which the rewards system of the present invention distributes rewards from one user account (e.g., the supervisory user account) to another user account (e.g., the subordinate user account). The rewards system can permit a supervisor to choose default allocation parameters, choose from a menu of suggested allocation parameters, or define his own allocation parameter. The rewards supervisor can permit the supervisor to set different or the same allocation parameters for each subordinate user account to which it is linked.

Rewards allocation parameters can be based on a predetermined quantity of activity, a predetermined quality or intensity of activity, a predetermined type of activity, or any combination thereof. For example, the rewards system can allocate predetermined rewards for a predetermined muscle group exercised as a result of physical activity, predetermined area(s) of the body exercised as a result of physical activity, predetermined miles jogged, predetermined calories burned, predetermined crunches completed, predetermined reps of weights lifted predetermined miles jogged with a predetermined heart rate, predetermined miles jogged at a predetermined pace, predetermined types of food the subordinate consumed, a predetermined number of calories the subordinate consumed, a predetermined number of times the subordinate visited the library, the grades received by the subordinate, etc. The rewards system also can permit the supervisor to set any other type of allocation parameter that is quantifiable and that can be compared to data tracked by a tracking device of the present invention. Examples include maximum rewards that can be distributed to a subordinate account in a predetermined period of time, specific days of the week that the subordinate performed his activity, specific hours of the day that the subordinate performed his activity, temperature at the time the subordinate performed his activity, time between activities, etc.

Once the supervisor sets up the rewards allocation parameters, the rewards system can associate the allocation parameters with the linked supervisory and subordinate user accounts.

In step 62, the rewards system can confirm that the rewards available in the supervisory user account are appropriate. This can include requesting that the supervisor confirm that the rewards associated with the supervisory user account are correct. This also can include confirming that the rewards associated with the supervisory user account meet a default value/quantity or meet the minimum value/quantity necessary to make a predetermined number of rewards distributions based on the user-defined allocation parameters. If the rewards associated with the supervisory user account are inappropriate, the rewards system can permit the supervisor to reset the rewards allocation parameters (as shown by arrow 63) or to purchase or otherwise acquire additional rewards (as shown in step 64). Any change in rewards allocation parameters or acquisition of rewards can be associated with the supervisory user account.

Thereafter, in step 66, the rewards system can permit the supervisor to associate restrictions to the subordinate account. Restrictions can include any rule that restricts how or when a user can use rewards associated with his user account. For example, the rewards system can permit the supervisor to prevent the subordinate from purchasing or accessing certain merchandise, service, or feature from the commercial transaction server. The rewards system also can permit the supervisor to prevent the subordinate from accessing the commercial transaction server during certain time periods.

After the supervisor completes the registration process of FIG. 2, a subordinate having a user account linked to the supervisory user account can log into the subordinate account and input data representative of the subordinate's activities, e.g., from an exercise tracking device. The rewards system then can allocate rewards to the linked user accounts based on the user's data.

If the supervisor wants to link his user account to additional user accounts after completing the initial registration process, the supervisor may do so by repeating steps 54-66.

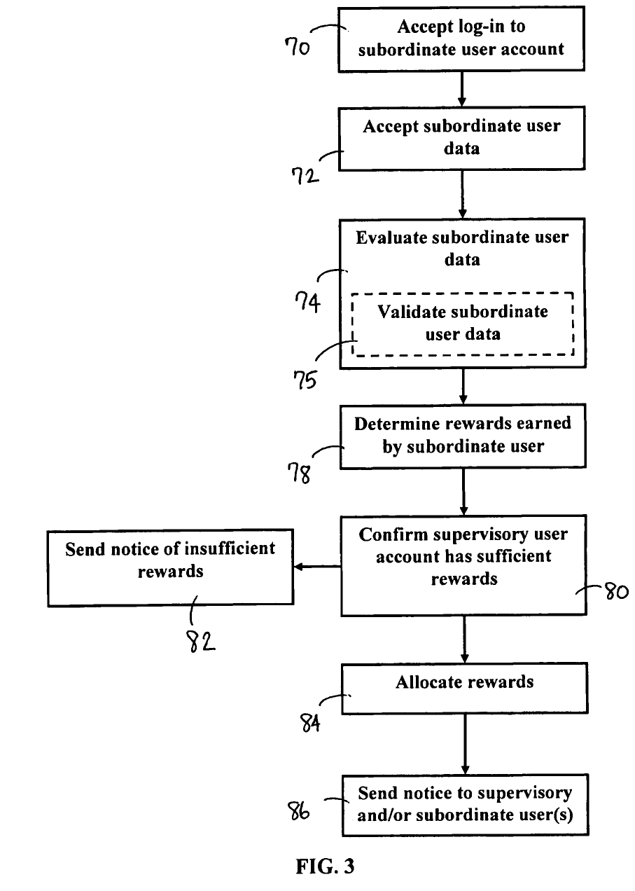

FIG. 3 illustrates one embodiment of a rewards allocation process for the rewards system of the present invention. In step 70, the rewards system can permit a subordinate to log into the subordinate's user account. When the subordinate logs into the subordinate user account, the rewards system can automatically, or by initiation from the subordinate, begin downloading data about the subordinate's activities from the subordinate's tracking device in step 72. Alternatively, if the subordinate did not use a tracking device or is unable to download his activity data, the rewards system can permit the subordinate to manually enter information about the subordinate's activities. During the supervisor registration process, the rewards system can permit the supervisor to activate or deactivate this manual entry feature.

Once the rewards system has completed accepting user data, the rewards system can evaluate the subordinate's data in step 74. For example, as shown in step 75, the rewards system can validate that the data exhibits expected characteristics. For example, this can include verifying that the data falls within a range of expected values and/or that the activity represented by the data occurred within a range of expected times or days. For example, the rewards system can determine whether the pace of physical activity indicated by the user data is within the physical capability of a user. The rewards system also can integrate with and access information from other applications that track the user's activity to validate that the activity indicated by the user data does not conflict with an activity tracked by another application, e.g., a calendar application that tracks a user's appointments. For example, the rewards system can verify that an activity indicated by user data occurred at a time during which the user was not scheduled for a separate activity. By validating that the data exhibits expected characteristics, the rewards system can reduce the likelihood that a user may attempt to cheat.

As part of the evaluation process in step 74, the rewards system also can perform other signal processing functions. For example, the rewards system can convert the user data to a predetermined format that may be useful for comparison to allocation parameters in step 78. The rewards system also may filter the user data to extract low frequency information from high frequency information. In some cases, low frequency information may be indicative of large scale movements, such as a user's steps, whereas high frequency information may result from vibrations. The high frequency information may be filtered out, thereby leaving only the low frequency information for use in subsequent analysis.

In step 78, the rewards system can determine the rewards earned by the subordinate based on the subordinate's user data and the allocation parameters previously set by the supervisor during the registration process. If the rewards system determines that the data meets one or more allocation parameters, in step 80, the rewards system can confirm that the supervisory user account to which the subordinate user account is linked has appropriate rewards for distribution to the subordinate user account. If the supervisory user account does not have appropriate rewards, the rewards system can send notice to the supervisor or supervisory user account. If the supervisory user account has appropriate rewards, the rewards system can allocate the appropriate rewards from the supervisory user account to the subordinate user account in step 84.

Thereafter, in step 86, the rewards system can notify the subordinate and/or the supervisor with information about the rewards allocation. Examples of information include what rewards were transferred, the amount of activity the subordinate performed, the quality of activity the subordinate performed, they type of activity the subordinate performed, and/or any other information requested by the subordinate and/or supervisor.

Once rewards have been transferred to a subordinate user account, the subordinate can immediately access the rewards. For example, the subordinate can redeem the rewards for merchandise, services, and/or features offered by the commercial transaction server. The merchandise, services, and features offered by the commercial transaction server can include those offered to the general public, special ones offered only to participants in the rewards system, ones offered at a discount only to users of the rewards system, or any combination thereof.

In alternative embodiments of the present invention, the rewards system also can permit the supervisor to review the subordinate's activity data before rewards are distributed to the subordinate user account. The rewards system then can give the supervisor the option to manually allocate rewards to the subordinate user account or to accept suggested allocations of rewards based on previously defined allocation parameters. The rewards system also can permit the supervisor to skip registration of allocation parameters. In that case, the rewards system can require that the supervisor manually allocate rewards to the subordinate user account or the rewards system can use one or more default allocation parameters.

In an alternative embodiment of the present invention, the rewards system can permit a subordinate to compile one or more wish lists, e.g., of merchandise, services, and/or features offered by the commercial transaction server. The rewards system can permit the supervisor to review the wish lists when the supervisor is purchasing rewards. The rewards system can allow the supervisor to assign one or more allocation parameters to each item on the wish list. Once the subordinate performs the appropriate activities that meet the allocation parameters, the rewards system can automatically request that the commercial transaction server send the corresponding merchandise to or activate the corresponding service or feature for the subordinate. The rewards system then can deduct that reward or the value of the reward from the supervisory user account.

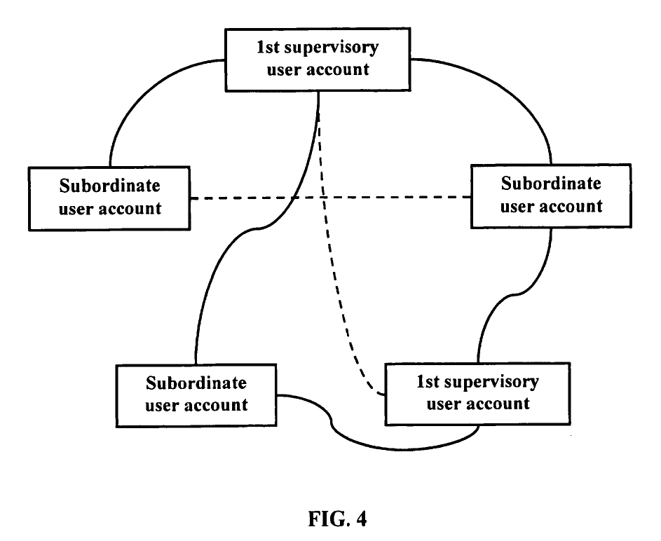

FIG. 4 illustrates relationships among multiple user accounts in accordance with one embodiment of the present invention. The rewards system can permit one supervisory user account to be linked to multiple subordinate user accounts. The rewards system also can permit a supervisor to associate different allocation parameters to each subordinate user account. Each subordinate user account also can be linked to more than one supervisory user account. The rewards system also can permit multiple supervisory user accounts to be linked together, e.g., to permit supervisors to transfer rewards between their respective user accounts or to purchase rewards for each other. The rewards system also can permit multiple subordinate user accounts to be linked together, e.g., to permit one subordinate to challenge another subordinate to a competition.

Rewards systems of the present invention also can permit any one of the user account holders (an “initiating competitor”) to challenge any one or more of the other account holders (a “challenged competitor”) to a competition. The rewards system can transfer rewards from the user account of the vanquished competitor to the user account of the victorious competitor in accordance with user-specified awards allocation parameters.

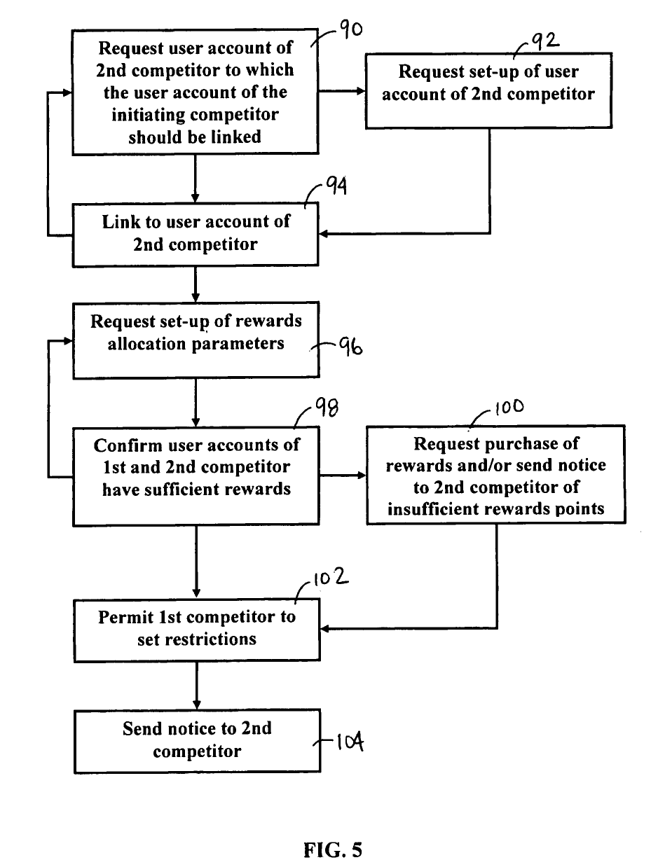

FIG. 5 illustrates one embodiment of a registration process for an initiating competitor to instigate a competition using the rewards system of the present invention. After an initiating competitor logs into his user account and indicates that he wants to initiate a competition, the rewards system can request that the initiating competitor identify the competitor user account to which the initiating competitor's user account should be linked in step 90. If the challenged competitor does not have a user account, the rewards system can request that the initiating competitor establish a user account for the challenged competitor in step 92. Thereafter, in step 94, the rewards system can link the user account of the challenged competitor to the user account of the initiating competitor. If the initiating competitor desires to challenge additional competitors, the rewards system can permit the initiating competitor to do so by reiterating steps 90-94. The rewards system also can link the user accounts of any additional competitors to the user accounts of the other competitors (either directly or indirectly through the user account of the initiating competitor) to facilitate rewards distribution at the conclusion of the competition.

The rewards system also can permit additional competitors to be added to the competition by any of the competitors after the initial registration process. Again, the rewards system can link the user accounts of any additional competitors added to the competition to the user accounts of the other competitors either directly or indirectly.

Once the user accounts of all the competitors have been linked, the rewards system can request that the initiating competitor set up rewards allocation parameters in step 96. Thereafter, the rewards system can associate the rewards allocation parameters with the linked competitor user accounts.

Since the allocation parameters may indicate the maximum amount or type of rewards that will be rewarded to the victorious competitor(s) by the vanquished competitor(s), the rewards system can confirm that all of the competitors have appropriate rewards associated with each of their individual user accounts to pay the victorious competitor(s) in step 98. If all of the competitors have appropriate rewards, the rewards system can reserve those rewards to prevent those rewards from being allocated elsewhere.

If any one of the competitors does not have appropriate rewards associated with his user account, the rewards system can permit the initiating competitor to reset the rewards allocation parameters in step 100. Alternatively, the rewards system can permit the initiating competitor or another competitor to purchase rewards for or transfer rewards to the user account of the competitor having inappropriate rewards. The rewards system also can send a notice to the competitor that he has inappropriate rewards associated with his user account. The rewards system also can permit one of the competitors to indicate to the rewards system that it should bypass step 98. Any change in rewards allocation parameters or acquisition of rewards can be associated with the appropriate user account(s).

Thereafter, in step 102, the rewards system can permit the initiating competitor to associate restrictions to the competitor user accounts. In step 104, the rewards system can send notices to the challenged competitors indicating the terms of the competition (e.g., the rewards allocation parameters set in step 96 and/or the restrictions set in step 102).

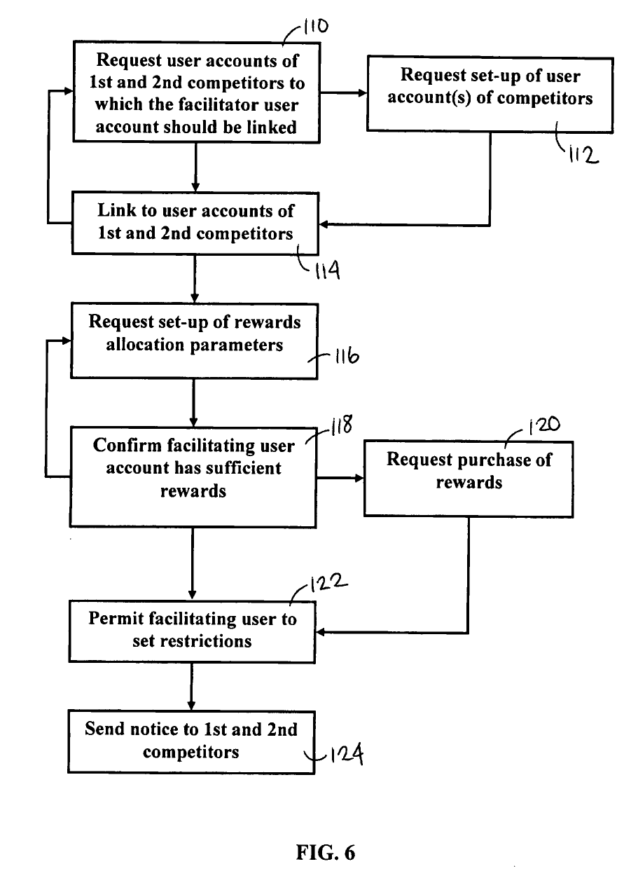

FIG. 6 illustrates a registration process for a facilitating user (e.g., a supervisor or a subordinate) to instigate a competition among other participants using the rewards system of the present invention. After a facilitating user or facilitator logs into his account, the rewards system can request that the facilitator identify the user accounts of the competitors (e.g., another supervisor and/or subordinate) he is challenging in step 110. If any of the competitors do not have an account, then, in step 112, the rewards system can request that the facilitator establish a user account for that competitor. Thereafter, in step 114, the rewards system can link the user accounts of all the competitors directly to the user account of the facilitator, thereby also indirectly linking all the user accounts of the competitors. The rewards system also can permit additional competitors to be challenged by the facilitator or by any of the competitors after the initial registration process. The rewards system also can link the user accounts of those newly added competitors to the user accounts of the facilitator and the other competitors.

Once the user accounts of all of the competitors have been linked to that of the facilitator and, thereby, to each other, the rewards system can request that the facilitator set up the rewards allocation parameters in step 116. Thereafter, the rewards system can associate the rewards allocation parameters with the linked facilitator and competitor user accounts.

Since the allocation parameters may indicate the maximum amount or type of rewards that will be rewarded to the victorious competitor(s), the rewards system can confirm that the facilitator has appropriate rewards associated with his user account to pay the victorious competitor(s) in step 118. Again, if all of the competitors have appropriate rewards, the rewards system can reserve those rewards to prevent those rewards from being allocated elsewhere.

If the facilitator does not have appropriate rewards, the rewards system can permit the facilitator to reset the rewards allocation parameters. Alternatively, in step 120, the rewards system can permit the facilitator to purchase or otherwise acquire more rewards, permit another user account holder to transfer rewards to the user account of the facilitator, or permit the facilitator to indicate to the rewards system that it should bypass step 118. Any change in rewards allocation parameters or acquisition of rewards can be associated with the appropriate user account(s).

Thereafter, in step 122, the rewards system can permit the facilitator to associate restrictions to the competitors' user accounts. In step 124, the rewards system can send notices to the challenged competitors indicating the terms of the competition.

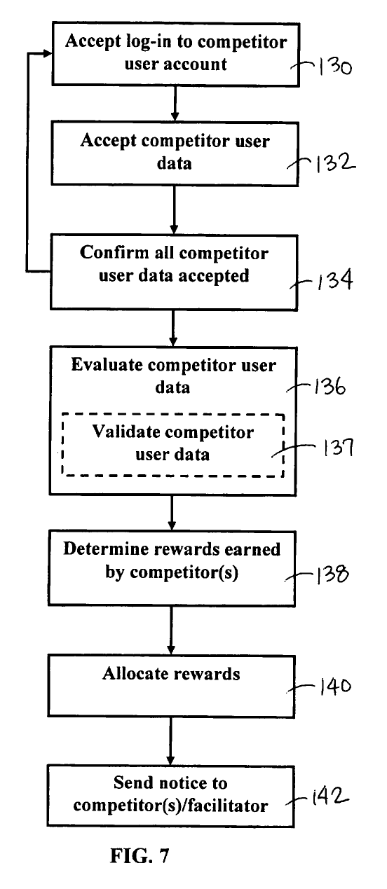

FIG. 7 illustrates one embodiment of a rewards allocation process for competitions administered by the rewards system of the present invention. Once a competitor performs activities in accordance with the terms of the competition, the rewards system can permit the competitor to log into his user account at step 130. In step 132, the rewards system can automatically, or by initiation from the competitor, begin downloading data about the competitor's activities from the competitor's tracking device. Once the download is complete, the rewards system can confirm whether user data from all of the competitors have been downloaded in step 134. If not, the rewards system can wait for additional competitors to download their respective data, repeating steps 130-134 until the user data for all of the competitors have been downloaded. Thereafter, in step 136, the rewards system can evaluate the competitor' data. For example, as shown in step 137, the rewards system can validate or verify that the competitor's data falls within a range of expected values.

Thereafter, in step 138, the rewards system can determine the rewards each competitor has earned in accordance with the allocation parameters previously set during the registration process. That is, the rewards system can determine whether each competitor is eligible for any rewards based on data about the competitor's activities and the rewards allocation parameters. If the rewards system determines that a competitor's data meets one or more allocation parameters, the rewards system can allocate or transfer the appropriate rewards from the facilitator's user account to the competitor's user account in step 140. In step 142, the rewards system can send notice to the facilitator and/or the competitors, e.g., regarding the results of the competition and/or the activities performed by each competitor.

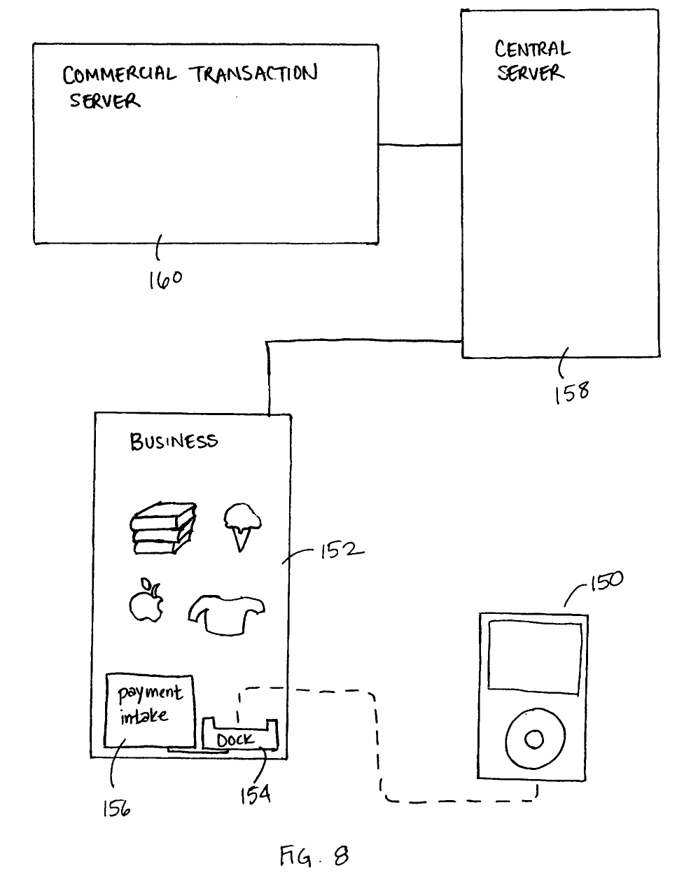

FIG. 8 illustrates rewards transactions in accordance with one embodiment of the present invention. Electronic device 150, which can be, e.g., an iPod™, can store information for one or multiple user accounts. Information can include identification information for each user account, password information for access to each user account, rewards associated with each user account, allocation parameters associated with each user account, type of performed physical activity for each user account, amount of performed physical activity for each user account, quality of performed physical activity for each user account, or any combination thereof.

If electronic device 150 stores rewards information, store-front businesses 152 can be provided with docks 154 that can exchange information with electronic device 150. This can allow users to redeem rewards for, e.g., merchandise or services offered by the store-front businesses. For example, dock 154 can be coupled to payment intake device 156, e.g., a cash register. When a cashier totals the value of the merchandise or services the user would like to purchase, the user may “pay” for a portion or the entire purchase by docking his electronic device 150 to dock 154 and indicating that he wishes to redeem rewards stored on electronic device 150. Payment intake device 156 can accept the rewards as payment and automatically deduct the redeemed rewards from user account information stored on electronic device 150.

As used herein, store-front businesses can include businesses having a physical location to which customers can go to purchase, e.g., merchandise or services. Store-front businesses can include bookstores, electronics stores, restaurants, grocery stores, department stores, etc.

The rewards system of the present invention also can include central server 158. Central server 158 can store user account information, including the rewards associated with and available for use by each user account. When a user wants to redeem rewards at store-front business 152, payment intake device 156 can communicate the information to central server 158. Central server 158 then can deduct the redeemed rewards from the appropriate user account.

Central server 158 can serve as the only repository of user account information or one of multiple repositories of user account information. Central server 158 can be dedicated to storing user account information or also be a commercial transaction server from which a user can redeem, purchase, or otherwise accumulate rewards. Central server 158 also can interact with other commercial transaction servers 160 hosted by partner businesses that also are participating in the rewards system of the present invention.

In alternative embodiments of the present invention, the rewards system can load a user's rewards onto a debit card (e.g., a gift card) that the user can use to redeem rewards at any store-front business or with any commercial transaction server that is participating in the rewards system. Once a user redeems the rewards, the rewards system can credit the debit card or a user account.

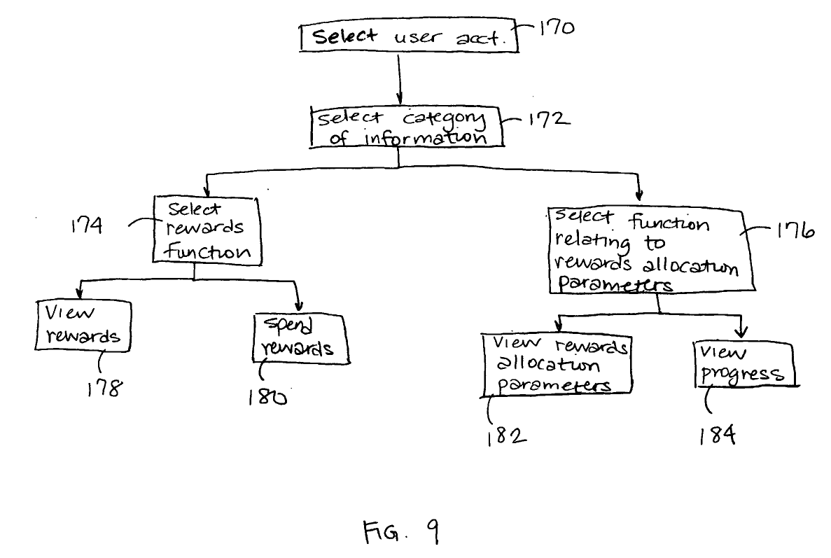

FIG. 9 illustrates functions for user-interaction with the rewards system in accordance with one embodiment of the present invention. These functions can be implemented on and accessible to a user from a portable electronic device (e.g., an iPod™), a local server (e.g., a user's personal computer), or a user-accessible central server. In step 170, a controller of the portable electronic device, local server, or central server can permit the user to select a user account. In step 172, the controller can permit the user to select a category of information the user wants to access, e.g., rewards or allocation parameters.

If the user selects the rewards category, the controller can permit the user to select a rewards function in step 174. For example, the user can view rewards associated with his user account (step 178) or choose to spend or redeem rewards (step 180).

If the user selects the category related to rewards allocation parameters, the controller can permit the user to select a function related thereto in step 176. For example, the user can view rewards allocation parameters associated with his user account (step 182). The controller also can track a user's progress in earning rewards in accordance with the allocation parameters and permit a user to view his progress on a display in step 184.

In addition to or instead of providing information in a visual format in steps 178-184, the controller also can be configured to provide the information in an audio format.

Although particular embodiments of the present invention have been described above in detail, it will be understood that this description is merely for purposes of illustration. Alternative embodiments of those described hereinabove also are within the scope of the present invention. For example, different permutations of the rewards system also are within the scope of the present invention.

Electronic device 13 and 150 of the present invention can be any electronic device that can log data about the activities a user has performed. For example, the electronic device can be any portable, mobile, hand-held, or miniature consumer electronic device. Illustrative electronic devices can include, but are not limited to, music players, video players, still image players, game players, other media players, music recorders, video recorders, cameras, other media recorders, radios, medical equipment, calculators, cellular phones, other wireless communication devices, personal digital assistances, programmable remote controls, pagers, laptop computers, printers, or any combination thereof. Miniature electronic devices may have a form factor that is smaller than that of hand-held devices. Illustrative miniature electronic devices can include, but are not limited to, watches, rings, necklaces, belts, accessories for belts, headsets, accessories for shoes, virtual reality devices, other wearable electronics, accessories for sporting equipment, accessories for fitness equipment, key chains, or any combination thereof. The rewards system also can be implemented on a personal computer.

In one embodiment of the present invention, electronic device 13 and 150 can be a portable media player similar to the iPod™. The electronic device can play media files having audio and/or visual information. Visual information can include text images, still images, and/or video images. The media files can be downloaded from a server, e.g., a user's personal computer, a commercial transaction server, or another local or central server.

The rewards systems of the present invention can be used to track any type of activity that can be tracked by passive or active tracking devices. Illustrative activities include fitness activities, performance on exams, visits to certain people or places, food eaten, calorie intake, activities described in the incorporated patent documents, or any combination thereof.

The above described embodiments of the present invention are presented for purposes of illustration and not of limitation, and the present invention is limited only by the claims which follow.

What is claimed is:

1. A method for permitting a first user to reward a second user for performing at least one predetermined activity, the method comprising:
linking a first user account to a second user account; and
requesting set-up of at least one rewards allocation parameter, wherein each rewards allocation parameter defines a rule by which rewards are distributed automatically between at least the first and second user accounts, wherein the at least one rewards allocation parameter is a function of the at least one predetermined activity.

2. The method of claim 1, further comprising:
accepting data from a portable electronic device, wherein the data is indicative of performed activity; and
automatically distributing rewards from the first user account to the second user account based on the data and the at least one rewards allocation parameter.

3. The method of claim 2, further comprising validating that the data exhibits at least one expected characteristic.

4. The method of claim 1, further comprising:
determining rewards to be distributed from the first user account to the second user account based on the data and the at least one rewards allocation parameter; and
determining whether the first user account has the determined rewards associated therewith.

5. The method of claim 1, further comprising requesting that rewards be purchased for the first user account from a commercial transaction server.

6. The method of claim 1, further comprising requesting that at least one restriction be associated with the first user account, the second user account, or both the first and second user accounts.

7. The method of claim 1, further comprising linking the first and second user accounts to a third user account, wherein each rewards allocation parameter defines a rule by which rewards are distributed automatically between at least two of the first, second, and third user accounts.

8. The method of claim 1, further comprising confirming the rewards associated with the first user account.

9. The method of claim 8, further comprising requesting that the at least one rewards allocation parameter be changed when the rewards associated with the first user account is inappropriate.

10. The method of claim 8, further comprising requesting purchase of rewards when the rewards associated with the first user account is inappropriate.

11. The method of claim 1, further comprising providing a list of one or more suggested rewards allocation parameters.

12. A method for permitting a first user to reward a second user for performing at least one predetermined activity, wherein the first user has a first user account and the second user has a second user account, the method comprising:
accepting first data from a first tracking device, wherein the first data is indicative of activity performed by the second user;
determining rewards earned by the second user based on the first data and at least one rewards allocation parameter, wherein each rewards allocation parameter defines a rule by which rewards are distributed automatically between user accounts; and
automatically distributing the determined rewards from the first user account to the second user account.

13. The method of claim 12, further comprising sending notice that rewards have been distributed.

14. The method of claim 12, further comprising validating that the first data exhibits at least one expected characteristic.

15. The method of claim 12, further comprising:
accepting second data from a second tracking device, wherein the second data is indicative of activity performed by a third user; and
determining that the third user did not earn rewards based on the second data and the at least one rewards allocation parameter.

16. The method of claim 12, further comprising permitting rewards associated with the second user account to be exchanged for merchandise, services, or features offered by a commercial transaction server.

17. The method of claim 12, further comprising confirming that the first user account has the determined rewards associated therewith.

18. The method of claim 17, further comprising sending notice that the first user account does not have the determined rewards associated therewith.

19. The method of claim 12, further comprising loading rewards associated with the second user account onto a debit card.

20. A method for permitting a first user to reward a second user for performing at least one predetermined activity, wherein the first user has a first user account and the second user has a second user account, the method comprising:
accepting first data from a first tracking device, wherein the first data is indicative of activity performed by the second user;
validating that the first data exhibits at least one expected characteristic; and
determining rewards earned by the second user based on the first data and at least one rewards allocation parameter, wherein each allocation parameter defines a rule by which rewards are distributed automatically between the first and second user accounts.

21. The method of claim 20, wherein validating that the first data exhibits at least one expected characteristic comprises verifying that the first data falls within a range of expected values.

22. The method of claim 20, wherein validating that the first data exhibits at least one expected characteristic comprises verifying that the activity indicated by the first data occurred within a range of expected times.

23. The method of claim 20, wherein validating that the first data exhibits at least one expected characteristic comprises verifying that the activity indicated by the first data occurred within a range of expected days.

24. The method of claim 20, wherein validating that the first data exhibits at least one expected characteristic comprises:
accessing data from a separate application that tracks a user's activities; and
verifying that the activity indicated by the first data does not conflict with an activity tracked by the separate application.

25. The method of claim 20, further comprising automatically distributing the determined rewards from the first user account to the second user account.

26. The method of claim 25, further comprising permitting rewards associated with the second user account to be exchanged for merchandise, services, or features offered by a commercial transaction server.

27. The method of claim 20, further comprising:
accepting second data from a second tracking device, wherein the second data is indicative of activity performed by a third user;
validating that the second data exhibits at least one expected characteristic; and
determining that the third user did not earn rewards based on the second data and the at least one rewards allocation parameter.

28. The method of claim 20, further comprising loading rewards associated with the second user account onto a debit card.

29. A portable electronic device comprising:
a display;
memory for storing rewards information associated with at least a first user account, wherein the rewards information indicates the rewards earned by a user in accordance with at least one rewards allocation parameter, wherein each rewards allocation parameter defines a rule by which rewards are distributed automatically between user accounts; and
a controller configured to access the memory for the rewards information associated with the first user account and to show the rewards information on the display.

30. The portable electronic device of claim 29, wherein:
the rewards information is associated with at least first and second user accounts; and
the controller is configured to permit a user to selectively access rewards information associated with either the first or second user accounts.

31. The portable electronic device of claim 29, wherein the controller is configured to permit a user to redeem the rewards at a store-front business.

32. The portable electronic device of claim 29, wherein the controller is configured to show on the display a user's progress in earning a reward in accordance with the at least one rewards allocation parameter.

33. A rewards system for permitting a first user to reward a second user for performing at least one predetermined activity, wherein the first user has a first user account and the second user has a second user account, the rewards system comprising:
a portable electronic device having memory;
at least one sensor that generates first data, wherein the first data is indicative of activity performed by the second user and wherein the first data is stored in the memory of the portable electronic device; and
a controller configured to determine rewards earned by the second user based on the first data and at least one rewards allocation parameter, wherein each rewards allocation parameter defines a rule by which rewards are distributed automatically from the first user account to the second user account.

34. The rewards system of claim 33, wherein the at least one sensor is coupled in wireless communication with the portable electronic device.

35. The rewards system of claim 33, wherein the controller is disposed in a server.

36. The rewards system of claim 33, wherein the controller is disposed in the portable electronic device.
